(19) United States
(12) Patent Application Publication
(10) Pub. No.: US 2022/0260093 A1
(43) Pub. Date: Aug. 18, 2022

(54) CONNECTION DEVICE

(71) Applicant: HYDAC MOBILHYDRAULIK GMBH, Sulzbach/Saar (DE)

(72) Inventor: Maximilian GRAF VON SPEE-MIRBACH, Saarbrücken (DE)

(21) Appl. No.: 17/608,800

(22) PCT Filed: Mar. 16, 2020
(86) PCT No.: PCT/EP2020/057101

§ 371 Date: Nov. 4, 2021

(30) Foreign Application Priority Data
May 31, 2019 (DE) 10 2019 003 873.8

(51) Int. Cl. F15B 1/26; G05D 16/20

(52) U.S. Cl. CPC F15B 1/26; E02F 9/2228; G05D 16/204; G05D 16/2024

(57) ABSTRACT

A connection device between at least one hydraulic pressure supply device, such as the pressure supply device of a mobile work machine, and at least one hydraulic consumer, such as a hydraulically actuatable work tool of at least one attachment device, having hydraulic connectors (2) at the side of the supply device and correspondingly couplable hydraulic connectors (6) at the side of the respective consumer, characterized in that by means of consumer-side data storage devices (8) data relating to the respective consumer is transmitted to the respectively assignable supply device so that, in the coupled state of the mutually assigned hydraulic connectors (2, 6), the respective consumer is individually supplied by its supply device with hydraulic medium of predeterminable pressure and volume flow.

The invention relates to a connection device between at least one hydraulic pressure supply device, such as the pressure supply device of a mobile work machine, and at least one hydraulic consumer, such as a hydraulically actuatable work tool of at least one attachment device, having hydraulic connectors at the side of the supply device and accordingly couplable hydraulic connectors, at the side of the respective consumer.

The supply of hydraulically actuatable work tools by the pressure supply device of a mobile work machine, in particular formed as a tractor, is common practice in particular in agricultural and forestry machine applications. Attachment devices for different tillage operations, providing the fields with seed or fertilizer and/or lifting or stacking devices are used, which can be operated by means of working cylinders or hydraulic motors. As attachment devices, these work tools can be provided on tractors themselves or a trailer that can be coupled to the tractor. For a mobile work machine designed as a construction machine and assigned attachment devices, the explanations regarding tractors apply accordingly. In any case, a relatively large number of connections in the form of connectors located at hydraulic hoses has to be made. In view of the different demands of the consumers to be connected in terms of hydraulic pressure and volume flow, the operator has to be careful to make sure that the respective consumers are connected exactly to the assigned supply connector of the tractor. Incorrect connections, for instance supplying a consumer with an impermissible pressure level and/or volume flow, can result in malfunction or destruction. Considering the frequently large number of attachment devices to be supplied and the corresponding number of hydraulic hoses, the connection procedures result in a considerable amount of time and work effort for the operator, who has to pay attention to the correct selection of hydraulic hoses for connection to the supply connections. To facilitate the selection of hydraulic hoses for coupling operations for the operator, it is state of the art, according to EP 2 554 884 B1, to provide markings on hydraulic hoses that provide an indication of the type of consumer to be supplied, which the operator can recognize. Despite such a marking, the problem of likelihood of confusion and harmful consequences because of possible faulty connections remains unsolved.

With regard to this difficulty, the invention addresses the problem of providing a connection device of the genus mentioned at the beginning, which permits the establishment of the coupling connections in a particularly easy and safe manner.

According to the present invention, this problem is solved by a connection device having the features of claim 1 in its entirety.

In accordance with the characterizing part of claim 1, an essential feature of the invention is that by means of consumer-side data storage devices data relating to the respective consumer is transmitted to the respectively assignable supply device so that in the coupled state of the mutually assigned hydraulic connectors, the respective consumer is individually supplied by its supply device with hydraulic medium of predeterminable pressure and volume flow. Because the data of the respective consumer is transmitted from the data storage device to the pressure supply device and are available for the control device of the pressure supply device, the latter can supply the respective consumer on the basis of its demand data and in that way reliably and according to demand. Thus, the operator can connect the hydraulic hoses without having to pay attention to the connectors. This means that coupling operations are not only quick and easy, but also particularly reliable, because malfunctions are prevented.

In advantageous exemplary embodiments, a consumer-side connector of the pressure supply is used to actuate a consumer or to provide a load-sensing pressure, wherein a further consumer-side connector of the same consumer permits the respective hydraulic medium to be returned to the pressure supply device. The data transmission not only ensures that the respective consumer is supplied with pressure as demanded, but also that for any connection of the hoses the return flow of the hydraulic medium is made as demanded for any connector selection.

The pressure supply device may comprise a pressure source, such as a hydraulic pump, and a return line to a reservoir, such as a tank. The hydraulic pump can advantageously be operated by the main drive motor of the work machine or by means of an additional drive of the work machine.

The pressure supply device can be controlled directly by a control unit or, additionally or alternatively, the control unit can control one valve device each installed between the pressure supply device and the hydraulic connectors at the side of the pressure supply device.

The arrangement can advantageously be made in such a way that the respective valve device is formed from individual valves or from a proportional valve each, preferably from a proportional directional valve, particularly preferably from a 4/3-way proportional valve. In the case of individual valves, each valve can be assigned to each of the hydraulic hoses for the supply or return flow of any consumer, while proportional valves can be assigned to both hoses of a respective hose pair.

The arrangement based on individual valves can advantageously be designed in such a way that at least four individual valves are provided, of which the first two are formed as 3-way pressure regulators and the other two as 2-way proportional valves, each of which can be connected at the outlet side to one of the hydraulic connectors and to each of which at the inlet side pressure is made available from one of the two 3-way pressure regulators for pressurizing the respective hydraulic connector. In this way, the two hydraulic connectors can be controlled independently of each other, to be able to pressurize both hydraulic connectors at the same time or to depressurize them towards the tank. In addition, this arrangement permits a connector piece of the hydraulic hose to be connected to any one of a plurality of hydraulic connectors of the work machine. The control unit of the work machine then based on the characteristic data or information from the data storage device automatically detects which hydraulic hose is connected and switches the assigned valve device accordingly. Here the 2-way proportional valves can in particular be 2/2-way proportional valves.

Advantageously, the respective data storage device passes its data to a controller that controls the pressure supply device and/or the valve device. The controller transmits the respective demanded hydraulic characteristics to the tractor's control unit so that the demanded parameter of the respectively assigned hydraulic hose are set. The controller can also overlay a signal that can be input by the operator of the tractor to ensure that the maximum values of consumers connected to concerning hydraulic hoses are not exceeded.

The data storage device can transmit the data to the controller by cable or wirelessly (transponder technology). Advantageously, for the latter a Bluetooth connection can be used.

Advantageously, the arrangement can be made in such a way that the respective data storage device is arranged on a consumer-side hydraulic hose or is integrated into the consumer-side connector. When installed in the connector, the storage is advantageously protected against harmful effects from the outside.

Subject of the invention is also a method for operating a connection device according to one of patent claims 1 to 9, wherein the method has the features of patent claim 10.

The invention is explained in detail with reference to the drawings below.

In the drawings:

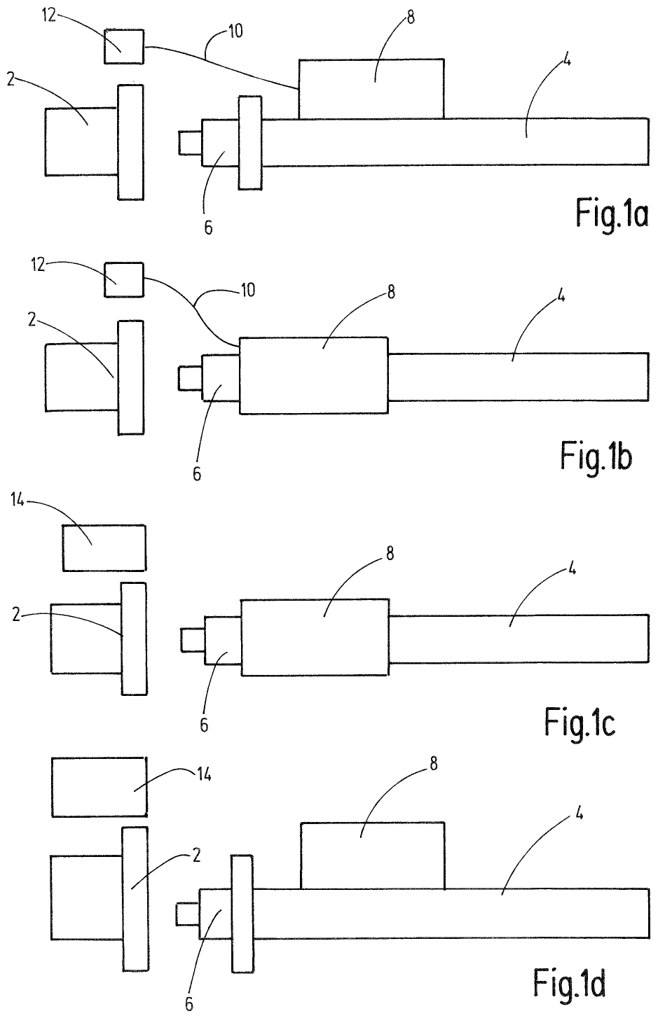

FIGS. 1a to 1d show, in a highly schematic simplified representation of four embodiments of the connection device according to the invention, each the connection area of a single hydraulic hose assigned to an attachment device and a partial connection area of a mobile work machine; and

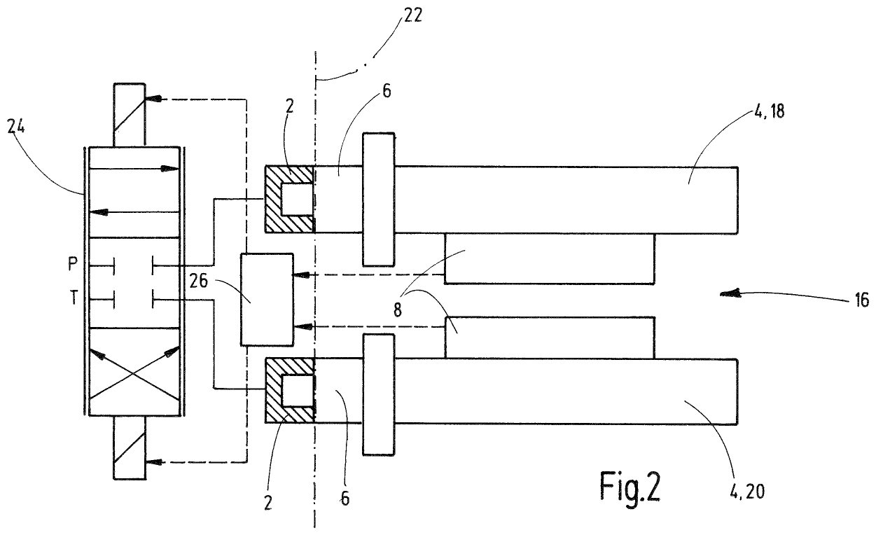

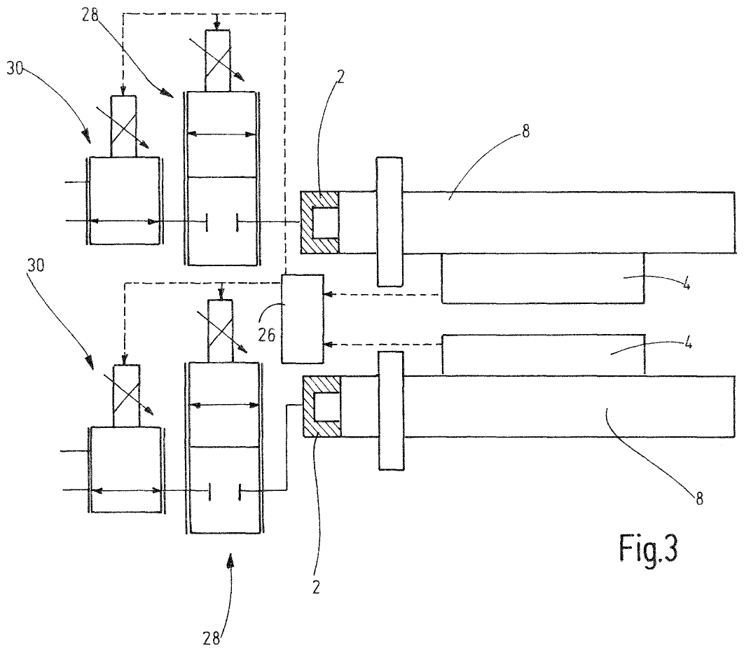

FIG. 2 and FIG. 3 show, in a correspondingly highly schematically simplified representation of a further embodiment, each only the connection area of a pair of hydraulic hoses assigned to a single load and connected to a partial connection area of a mobile work machine.

In the figures, hydraulic connectors at the supply end and for instance belonging to a mobile machine (not shown), such as a tractor or construction machine, are designated by the reference numeral 2, wherein with said hydraulic connectors hydraulic hoses 4 can be coupled, of which only the end section having a connector piece 6 is shown each. The hydraulic hoses 4 are connected to a supply connector of an attachment device (not shown) for supplying it with pressure or to the return connector of an attachment device for returning the hydraulic medium.

In the embodiment of FIG. 1a, a data storage device 8 is attached to every hydraulic hose 4 in the vicinity of the connector piece 6, wherein the electronic board of said data storage device stores the characteristic data relating to the assigned hydraulic hose 4, i.e. the data as to whether it is a pressure supply hose, a return hose or a load-sensing hose explained below. Depending on whether it is a pressure supply hose or a return hose, the data are stored as to which supply pressure and volume flow are required. In the example of FIG. 1a, this data gets to the control unit of the work machine via a cable 10 and a plug 12 during the coupling process. The control unit processes the data in order to control the pressure supply device of the work machine, preferably by means of a valve device, in such a way that the pressures and/or volume flows complying with the demands of the consumer assigned to the hose 4, are available at the concerning hydraulic connector 2. The consumer can each be designed as double-acting working cylinders, as hydraulic motors or as single-acting working cylinders. Only one single hose is routed to the single-acting working cylinder, which can be alternately fluidically connected to either a pressure port P or a tank port T. Thus regardless of which hose 4 connects which consumer to the respective hydraulic connector 2 by a coupling, a trouble-free operation is ensured.

The embodiment of FIG. 1b differs from the example of FIG.1a only in that the data storage device 8 is not attached to the hose 4, but is integrated into the connector piece 6. In particular under harsh operating conditions, such as when the attachment devices are used in agriculture and forestry or on a construction site, in that way, the electronics of the data storage device 8 are better protected against damaging external influences from the outside.

In the embodiment of FIG. 1c, the data storage device 8 is also integrated into the connector piece 6. In contrast to the previous example, however, the signal transmission to the work machine is wireless. Suitable transmission systems for this purpose are state of the art. For instance, systems that detect a passive transponder in the board of the data storage device 8 and read out the stored data for the control unit of the work machine. A passive transponder is such a radio communication device that gets its energy for transmitting the parameters to the control unit from an electric field of the control unit or a transmitter unit connected to the former.

Alternatively, an active transponder can be used, which is independent of an electric field. In this case, the transponder of the respective hose 4 can have a power supply that is independent of the other transponders, or a central power supply is provided that supplies power to several transponders. Owing to the greater energy available with active transponders, they are particularly well suited for transmitting characteristic data whose required/permitted values change as a function of the operating situation.

One such characteristic data value that changes as a function of the operating situation, is the load-sensing pressure that may be present at the connector of the load-sensing hose. The load sensing pressure transmits the load pressure requested by the consumers to the hydraulic pump of the mobile work machine. In this way, the hydraulic pump can adapt its pressure and/or volume flow to the pressure and/or volume flow demanded by the consumer, such that hydraulic power losses are minimized.

Consequently, the load-sensing pressure can be transmitted via a radio link or cable from the data storage device 8 and/or hydraulically via the load-sensing hose. The data storage device 8 can also be used solely to identify the load sensing hose.

In the embodiment of FIG. 1d, the transmission of the characteristic data from the data storage device 8 to the control unit of the work machine is wireless.

However, in contrast to the previous example, the data storage device 8 is a separate component from the connector piece 6 and is attached to the hose 4. Here the data storage device 8 can be spaced apart from the connector piece 6 as shown in the schematic representation.

FIG. 2 illustrates an embodiment in which two hydraulic hoses 4 from each of the consumers are mechanically interconnected to form a hose pair 16, wherein the one hose or hose pairs 16 forms the pressure hose 18 and the other hose forms the return hose 20. For all hose pairs 16, at the coupling area at the interface designated by the reference numeral 22 in FIG. 2 a coupling pair having two hydraulic connectors 2 is provided, to which for each coupling pair a proportional valve 24 is assigned. In the example shown, the latter is formed by a 4/3-way proportional valve, which can be electrically actuated and controlled by a controller 26 of the control unit of the work machine. The controller receives the characteristic data of the hoses 18, 20 of the hose pair 16 from the data storage device 8 of the respective hose 18, 20 via wireless connection. At the input end, the proportional valve 24 is connected to the pressure port P and the tank port T of the pressure supply device of the work machine, and on the output end to the one and the other of the hydraulic connectors 2 of the concerning coupling pair. In this arrangement, the hose pair 16 of any consumer can be connected to any one of these coupling pairs. Because the controller 16 recognizes which of the hoses 18, 20 is the pressure hose and which is the return hose using the characteristic data provided by the data storage device 8, the controller 26 controls the directional control valve 24 to the appropriate valve position in which one of the hoses 18, 20 is connected to the pressure port P and the other is connected to the tank port T. At the same time, the directional control valve 24 sets the desired flow rate based on its proportionality. In this way, the supply according to demand is ensured when any hose pairs 16 are connected to the connectors 2 of any coupling pairs at the interface 22 of the work machine.

FIG. 3 shows a further embodiment that differs from the previous example with regard to the partial connection area of the mobile work machine. Instead of the 4/3-way proportional valve, two 2/2-way proportional valves 28 and two 3-way pressure regulators 30 are provided. Each of the two hydraulic connectors 2 of a consumer is connected to the output end of one of the two 2/2-way proportional valves 28, respectively, such that the two hydraulic connectors 2 can be supplied with pressure from the pressure port P independently of each other and/or can be connected to the tank port T for pressure relief. For this purpose, the input of the respective 2/2-way proportional valve 28 is connected to the output end of one of the two 3-way pressure regulators 30, the input ends of which are connected to the pressure supply port P and to the tank port T, respectively.

Both the two 3-way pressure regulators 30 and the two 2/2-way proportional valves 28 are each actuated by means of an electromagnetic actuator controlled by the controller 26 of the control unit of the work machine.

In this way, the further embodiment according to FIG. 3 offers the option of controlling the consumer using different strategies. For instance, both connectors can be relieved towards the tank port T to realize a kind of floating position, or both connectors are pressurized by at least part of the pressure from the supply port P, such that for instance, a piston of a double-acting work cylinder is clamped in a predeterminable position between two pressure chambers.

The data storage devices 8 shown in FIG. 1a and FIG. 1d are arranged near the connector piece 6 to make the cable 10 or the transmission distance of the wireless connection short. Then, if a cable 10 is used, the risk of a cable being damaged in the harsh working conditions of agricultural machinery and construction equipment is reduced. In the case of the wireless connection, the proximity between the data storage device 8 and the connector piece 6 ensures that the characteristic data is transmitted without interference, even though in particular ferromagnetic metal parts are in the direct vicinity and are moved. In exemplary embodiments not shown in the drawing, the data storage device 8 and the connector piece 6 are not in close proximity to each other.

If, in accordance with the embodiments shown in FIG. 1a and FIG. 1b, a cable 10 with a plug 12 is used, when the attachment is being connected the connector piece 6 can first be coupled to the hydraulic connector 2 and then the plug 12 can be coupled to the assigned counterpart of the mobile work machine.

In particular, in the case a tractor is used as a mobile work machine, two or more attachments can be connected to the former.

However, the mobile work machine can in particular also be designed as a construction machine.

1. A connection device between at least one hydraulic pressure supply device, such as the pressure supply device of a mobile work machine, and at least one hydraulic consumer, such as a hydraulically actuatable work tool of at least one attachment device, having hydraulic connectors (2) at the side of the supply device and correspondingly couplable hydraulic connectors (6) at the side of the respective consumer, characterized in that by means of consumer-side data storage devices (8) data relating to the respective consumer is transmitted to the respectively assignable supply device so that, in the coupled state of the mutually assigned hydraulic connectors (2, 6), the respective consumer is individually supplied by its supply device with hydraulic medium of predeterminable pressure and volume flow.

2. The connection device according to claim 1, characterized in that a consumer-side connector (6) of the pressure supply is used to actuate a consumer or to provide a load-sensing pressure, and a further consumer-side connector (6) of the same consumer permits the respective hydraulic medium to be returned to the pressure supply device.

3. The connection device according to claim 1, characterized in that the pressure supply device comprises a pressure source (P), such as a hydraulic pump, and a return line to a reservoir, such as a tank (T).

4. The connection device according to claim 1, characterized in that the pressure supply device can be controlled directly by a control unit (22) or in that, additionally or alternatively, the control unit (22) controls one valve device (24) each, which is installed between the pressure supply device and the hydraulic connectors (2) at the side of the pressure supply device.

5. The connection device according to claim 1, characterized in that the respective valve device is formed from individual valves or from a proportional valve, preferably from a proportional directional valve, particularly preferably from a 4/3-way proportional valve (24).

6. The connection device according to claim 1, characterized in that at least four individual valves are provided, of which the first two are formed as 3-way pressure regulators (30) and the other two are formed as 2-way proportional valves (28), each of which can be connected at the outlet side to one of the hydraulic connectors (2) and to each of which at the inlet side pressure can be made available from one of the two 3-way pressure regulators for pressurizing the respective hydraulic connector (2).

7. The connection device according to claim 1, characterized in that the respective data storage device (8) passes on its data to a controller (26) which controls the pressure supply device and/or the valve device (24).

8. The connection device according to claim 1, characterized in that the data storage device (8) transmits the data to the controller (26) by means of cable (10) or wirelessly.

9. The connection device according to claim 1, characterized in that the respective data storage device (8) is arranged on a consumer-side hydraulic hose (4, 18, 20) or is integrated into the consumer-side connector (6).

10. A method for operating a connection device for a mobile work machine having an attachment device to be connected and according to claim 1, characterized in that the consumer-side connectors (6) are randomly connected to the connectors (2) of the pressure supply device, in that the signal transmission is established between the data storage devices (8) of the attachment device and the respective control device (26) of the work machine, in that the control device (26), by controlling the pressure supply or valve device (24), causes the latter to deliver the hydraulic medium to the attachment device at a pressure and volume flow that are individually adapted to this attachment device, which are stored as data in the assigned data storage device (8).
